(19) United States
(12) Patent Application Publication
(10) Pub. No.: US 2021/0141700 A1
(43) Pub. Date: May 13, 2021

(54) Implementation of Multiple Independent Safety-Critical Software Functions in a Single Integrated Circuit

(71) Applicant: Arjen Roodselaar, Fremont, CA (US)

(72) Inventor: Arjen Roodselaar, Fremont, CA (US)

(21) Appl. No.: 16/679,225

(22) Filed: Nov. 10, 2019

(51) Int. Cl. G06F 11/20; G07C 5/00; G07C 5/08

(52) U.S. Cl. CPC G06F 11/2023; G06F 2201/85; G07C 5/085; G07C 5/008

(57) ABSTRACT

In an embodiment, an integrated circuit includes a first fault domain that includes a first set of programmable logic gates configured to run a first program to create a first output signal. In addition, the integrated circuit includes a second fault domain including a second set of programmable logic gates configured to run a second program to create a second output signal. The integrated circuit further includes a digital communication channel in communication with the first fault domain and second fault domain, the digital communication channel itself including data access control logic configured to mediate communication between the first fault domain and the second fault domain without the need for an operating system.

### BACKGROUND

Safety critical systems such as those found in avionics or ride-by-wire driving systems in modern cars are made up of multiple software programs, each performing a specific task or function. To guarantee the performance of each program, and of the system as a whole, these programs need to be isolated from one another such that a failure in the performance of one program will not affect the performance of another program. Where programs and functions need to interact, any interface connecting such programs and functions to one another must be carefully managed such that a failure in one program or function cannot traverse the interface, or in any other way negatively impact performance of other functions and programs.

Manufacturers of such safety critical systems are required to demonstrate and guarantee these properties in both their designs and their products, and building the body of evidence through exhaustive tests is resource intensive and expensive. Reducing the amount of complexity in these systems while maintaining the reliability properties is key to reducing the cost of these systems and staying competitive in the market.

Traditionally each function and program is executed by a dedicated microprocessor, each with its own memory and its own additionally required resources such as, for example, coprocessors, sensors, and actuators. Dictated by their programs, each processor is connected to only the required communications interfaces or busses allowing for deterministic interactions between the different functions.

Newly developed safety critical systems often do not allow for the use of a single microprocessor per function because of requirements with respect to hardware cost, physical dimensions, weight and total system power consumption. In order to meet these additional requirements, the functions are executed using a smaller number of more powerful microprocessors. But multiple functions are now sharing (and competing for) resources such as memory and communication interfaces. This makes it significantly more difficult to guarantee correct operation of each function and the system as a whole, which leads to additional cost building the required evidence.

The problem stated above is currently solved in the followings ways: 1) the addition of an operating system between the hardware and programs, tasked with enforcing isolation between programs by carefully managing the hardware resources (requiring the use of a program that may not be infallible, and that is not strictly necessary to run the programs and functions); 2) disabling many of the advanced features of current microprocessors in order to make it easier to provide guarantees with respect to their performance (thus causing the purchase of a more expensive chip or chips than is necessary); and 3) using more powerful hardware in order to provide for enough slack in the system so that that no single program can exhaust the shared resources (again, causing the purchase of a more expensive chip or chips than is necessary).

The general-purpose microprocessors used in new safety critical systems use only a fraction of their logic/transistors to execute program code. A significant portion of the logic is used to implement functionality to support an operating system, provide average throughput performance improvements through the use of multiple compute cores, out-of-order execution, branch prediction, and speculative execution, and shared interconnects to high speed communication interfaces such as Ethernet and PCI Express. The shared resources are often disabled because the high-speed interfaces are not applicable in safety critical applications. The performance enhancing features make it hard to determine the worst-case execution characteristics of the programs executed on the processor and additional performance capacity is to be reserved/left unused to provide safe margins in timing.

For an operating system to provide the illusion of multiple programs executing in parallel, each program is in turn and for a short duration of time, given exclusive access to the processor and associated hardware. In order to maintain the safety properties of the system the runtime characteristics of each function must be understood such that these slices of time for each program can be pre-planned.

The operating systems used by these systems are carefully crafted to enforce isolation between programs and manage shared resources. Providing the evidence needed to guarantee safety properties to such complex software is a significant task, and often makes up a significant portion of the evidence for the safety properties of the entire system. By removing much of this functionality from the system and implementing the remainder in hardware logic, the total body of evidence used to guarantee system safety properties is reduced.

Finally, general purpose microprocessors need to accommodate a wide set of use-cases, including general industrial applications, internet of things, telecommunications, robotics etc. As a result, these devices cater to the majority use cases, with safety-critical applications representing only a small portion of the market. Thus, manufactures of safety-critical applications must provide evidence that show that features added to these microprocessor designs do not affect the safety properties of the system, thereby increasing the cost of the overall system.

Thus, a need exists for a chip that employs a system that reduces the complexity of safety-critical systems while increasing the fault tolerance of such systems, by (1) eliminating the need for a common operating system; (2) by eliminating functions that are not required and/or not used; and (3) by using chips that are only as powerful as is necessary when resources are not shared.

### SUMMARY

In an embodiment, an integrated circuit includes a first fault domain that includes a first set of programmable logic gates configured to run a first program to create a first output signal. In addition, the integrated circuit includes a second fault domain including a second set of programmable logic gates configured to run a second program to create a second output signal. The integrated circuit further includes a digital communication channel in communication with the first fault domain and second fault domain, the digital communication channel itself including data access control logic configured to mediate communication between the first fault domain and the second fault domain without the need for an operating system

In another embodiment, a method comprises running a first program in a first fault domain on an integrated circuit to create a first output signal. The first output signal is sent to a second fault domain on the integrated circuit via a digital communication channel that includes data access control logic configured to mediate communication between the first fault domain and the second fault domain without the need for an operating system. The first output signal is then processed by a second program in the second fault domain to create a second output signal necessary for a safety-critical function, the processing by the second program being performed concurrently with and independently from the first program. The second output is included in a safety critical control signal.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system on a chip including multiple fault domains and at least one data channel access control and peripheral access control, according to an embodiment of the invention.

FIG. 2 is a flow chart of a process for providing a safety critical control signal in chip including multiple fault domains, according to an embodiment of the invention.

FIG. 3 is a flow chart of a process for providing a safety critical control signal in chip including multiple fault domains, according to an embodiment of the invention.

### DETAILED DESCRIPTION

One or more of the systems and methods described herein describe a system for, and ways of, providing a safety critical control signal using a single chip with multiple fault domains and at least one data channel access control and peripheral access control. As used in this specification, the singular forms “a” “an” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof, as the context dictates.

Instead of using an operating system to provide isolation between multiple programs running on fixed hardware microprocessors, in an embodiment, the minimum required functionality of a microprocessor and resources needed to execute safety critical functions using an integrated circuit with programmable logic are implemented. Programmable logic is used to allow tailoring the hardware resources to support the safety critical nature of the software executing in the system, thereby allowing the system manufacturer to tailor to their needs more specifically, as well as to take advantage of economies of scale when purchasing these integrated circuits.

In an embodiment, programmable logic includes a field-programmable gate array. Each program on a computer chip is mapped to a dedicated copy of the hardware and logic needed to execute their function, such that no resources need to be shared between functions unless desired. Where interaction between functions is needed, interfaces, also called data channels, are created between the different programs using the programmable hardware resources. The communication between two such functions or programs are mediated by a data channel access control programmed into the circuit, thus obviating the need for an over-arching operating system. The specific communication interfaces used in different markets (aerospace, automotive, space, military) can be implemented using programmable hardware resources and associated with the function requiring the interface. When external resources are to be shared between functions, such as memory and communication interfaces, hardware logic is used to enforce partitioning of such resources.

FIG. 1 is a block diagram of a system on a chip including multiple fault domains and at least one data channel access control and peripheral access control, according to an embodiment of the invention. In an embodiment, isolation barriers 101 define fault domains 102a, 102b, 102c, and 102n. Each fault domain includes a CPU implemented using programmable logic gates configured to run a program to create an output. In an embodiment in FIG. 1, a first fault domain 102a includes CPU 103a comprising a first set of programmable logic gates configured to run computer program 104a, through a hardware interface 105a. In addition, the chip includes fault domain 102b that includes CPU 103b, comprising a second set of programmable logic gates configured to run computer program 104b through hardware interface 105b. CPU 103c is within a third fault domain comprising a third set of programmable logic gates. One skilled in the art will understand that with regard to the fault domains, CPUs, and computer programs described herein, the terms first, second and third, are labels intended to distinguish one component (e.g., fault domain, CPU, or computer program) from another.

For the purposes of the present invention, programmable logic gates are electric components used to create reconfigurable digital circuits. These gates allow for integrated circuits to be produced without a specified function at the time of manufacture. Before use, the logic gates are programmed and/or reconfigured using a special program to perform the logic function of a specific digital circuit.

In an embodiment, isolation barriers 101 are physical barriers that separate the various fault domains. In an embodiment, the logic gates of an integrated circuit are only used in one digital circuit/fault domain at a time without being electrically connected to the logic gates in another fault domain. From this, one skilled in the art will understand that circuits and fault domains made up of unconnected sets of programmable logic gates operate independently of one another and so a fault in one domain cannot propagate across isolation barrier 101.

In and embodiment, hardware interfaces 105a, 105b, 105c and 105n include software libraries comprising peripheral and data channel device drivers and utilities tailored for use by the computer program in each fault domain to interact with the hardware and perform its function.

Because CPU 103a and computer program 104a are in a different fault domain from CPU 103b and computer program 104b, a fault occurring in CPU 103a, or in computer program 104a, will not affect CPU 103b, nor will it affect computer program 104b, or any output created when CPU 103b runs computer program 104b. In addition, because CPU 103a and computer program 104a are in a different fault domain from CPU 103b and computer program 104b, CPU 103a can run computer program 104a independently of and concurrently with CPU 103b running computer program 104b. Likewise, CPU 103b can run computer program 104b independent of and concurrent with CPU 103a running computer program 104a. For the purposes of the present invention, the term concurrent means at the same time, without sharing processor time, or multiplexing, or alternating the processing or running of either program. One skilled in the art will understand that a fault is an accidental condition that causes a functional unit to fail or to perform its required function, or a defect that causes a malfunction.

In communication with both fault domain 102a and 102b is the first data channel, which is mediated by data channel access control 106a. Data channel access control 106a manages communication between fault domain 102a and fault domain 102b by means of mediation logic that is configured to run with neither the need for, nor the use of, a common operating system shared by fault domain 102a, fault domain 102b, and data channel access control 106a. In this way, faults or errors occurring in one fault domain are further isolated from the proper running of the components and computer program in another fault domain.

In an embodiment, a data channel is a one-to-one channel, with one source and one sink. In an embodiment, a data channel is a one-to-many channel with one source and multiple sinks. In an embodiment, a one-to-many data channel is used to implement a data bus configured to allow a sensor measurement to be communicated with several functions that need such input.

In an embodiment, a data channel can be a queue, such that each value sent by the source is intended to be received by the sink(s). In an embodiment, a data channel can be a sampling channel, such that the sink publishes new values at a given rate, but the sink can only read the latest data value at any given time. In an embodiment, a sampling channel is used for sensor data where the source may produce data at a higher rate than the sink needs, and only the latest measurement is relevant for the sink.

In an embodiment, the communication between one fault domain (e.g., first fault domain 102a) and another fault domain (e.g., second fault domain 102b) is mediated by data access control logic (also called mediation logic) which is implemented in hardware in the circuitry, thus avoiding the need for an operating system. In an embodiment, the mediation logic is programmed into a set of programmable logic gates, rather than in software.

In an embodiment, the integrated circuit in FIG. 1 includes a second data channel in communication with fault domain 102b and 102c, and is mediated by data channel access control 106b. In an embodiment, the second data channel can be in communication with peripheral Z via Peripheral Z/Second Access Channel, and can include peripheral access control logic to mediate communication between at least one of the fault domains and peripheral Z.

As an example of mediation that that can happen (but not the only example), in an embodiment, if the sink expects data at a specific rate (e.g., 20 measurements per second) and a fault in the source causes data to flow at a rate of 50 values per second to be sent into the channel, the sink could get overwhelmed and cause a failure in that domain. Thus, the mediation component of the channel, data access control logic 106a, is configured to prevent the source from sending more than 20 values per second. In an embodiment, a set of data access control logic is programmed according to certain policies that can be different for each channel. In an embodiment, the data access control logic can be programmed for the specific type of data being transmitted. In an embodiment, the data access control logic can be programmed to be different for specific data.

In an embodiment, peripheral X, peripheral Y, and peripheral Z are external resources that provide inputs to the programs to compute one or more control signals; devices such as actuators or motors (not shown) are sent the output signals to control some part of the system. In an embodiment, RAM A, RAM B, RAM C, and RAM N, each in its own fault domain, are specific to the CPU in that fault domain, and hold the program instructions and program state for the functionality provided in that fault domain. For example, RAM A is specific to CPU 103a; RAM B is specific to CPU 103b; RAM C is specific to CPU 103c, and so on.

FIG. 2 is a flow chart of a process for providing a fault tolerant safety critical control signal in chip including multiple fault domains, according to an embodiment of the invention. At 201, a CPU runs a first program within a first fault domain to create a first output. One skilled in the art will appreciate that the term fault domain refers to a domain defined by software and hardware on a single chip such that a fault or error that occurs within that domain will not bleed over or effect other fault domains on that chip. Once the first output signal is created, at 202, it is sent to a digital communication channel that is in communication with the first fault domain. At 203, the mediation logic determines whether the first output signal satisfies a predefined policy. If the mediation logic determines that the first output signal satisfies the predefined policy, the signal is sent, at 204, to a second fault domain for further processing. If the mediation logic determines that the first signal does not satisfy the predefined policy, the data is not passed. In an embodiment, if the mediation logic determines that the first signal does not satisfy the predefined policy, a signal can be sent indication that some corrective measure is to be taken. In an embodiment, if the mediation logic that the first signal does not satisfy the predefined policy, then an error signal can be sent that can be used by a system health and/or status monitor to detect that a channel access policy was violated.

In an embodiment, the digital communication channel is in communication with both the first fault domain and the second fault domain, with the communication being mediated by a policy using an independent digital circuit using programmable logic that performs its function without input from and concurrent with the CPUs in the first and second fault domains and independent of an additional program such as an operating system. This independence from an operating system further isolates the first fault domain from the second fault domain, and further protects one fault domain from a fault or error that occurs in the other fault domain. In an embodiment, the digital communication channel is also a fault domain.

At 205, the processed signal is further processed in the second fault domain in a way that is independent of and concurrent with any processing or calculations being performed in the first fault domain, creating a second output signal. A determination can then be made, at 206, to send the second output signal to another fault domain for a variety of reasons, including additional processing. If the decision is made to refrain from sending the second program to an additional fault domain, in an embodiment, at 208, the second output signal is included in a safety critical control signal, and at 209, the safety critical control signal is sent to an actuator for control of a safety critical mechanism or system. If, however, additional processing is determined to be necessary, then the second output signal is sent to an additional fault domain (e.g., a third fault domain) at 207 for additional processing.

One skilled in the art will understand that the term “sent” or “sending” for a signal can include sending directly, sending indirectly, or sending part of the signal directly and part of the signal indirectly.

FIG. 3 is a flow chart of a process for providing a safety critical control signal in chip including multiple fault domains, according to an embodiment of the invention. At 301, a first program is run in a first fault domain to create a first output. Independently and concurrently, at 307, a program is run in a different fault domain (labeled fourth fault domain in FIG. 3) to create an additional output signal.

At 302, the first output is sent to a first digital communication channel (labeled a third fault domain in FIG. 3) that employs mediation logic to interface with multiple fault domains. In an embodiment, the mediation program obviates the need for a common operating system running across multiple fault domains. At 303, the mediation logic determines whether the first output signal satisfies a predefined policy, and if so, it is sent to a second fault domain for further processing into a second output, at 304. In an embodiment, At 308, the additional output signal from the fourth fault domain is sent to a second digital control channel that, like the first digital communication channel, interfaces with multiple fault domains using mediation logic that obviates the need for a common operating system. At 309, the mediation logic determines whether the additional output signal satisfies a predefined policy, and if so, it is sent to a second fault domain for further processing into a second output, at 304.

In an embodiment, at 305, the first output signal and additional output signal are included in a safety critical control signal, and at 306, the safety critical control signal is sent to an actuator for a safety critical use.

One skilled in the art will understand, in the context of embodiments of the invention, that the term “a combination of” includes zero, one, or more, of each item in the list of items to be combined.

For the purposes of the present invention, the term computer program or computer code includes software, firmware, middleware, and any code in any computer language in any configuration, including any set of instructions or data intended for, and ultimately understandable by, a computing circuit or combination of computing circuits.

One skilled in the art will understand that the order of elements described in each figure is given by way of example only. In an embodiment, the order of elements performed can be changed in any practicable way.

In some embodiments, the processes in FIGS. 2 and 3, or any portion or combination thereof, can be implemented as software modules. In other embodiments, the processes in FIGS. 2-4 or any portion or combination thereof, can be implemented as hardware modules. In yet other embodiments, FIGS. 2-4, any portion or combination thereof, can be implemented as a combination of hardware modules, software modules, firmware modules, or any form of program code.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A method comprising:
running a first program in a first fault domain on a chip to create a first output signal;
sending the first output signal from the first fault domain to a second fault domain via a digital communication channel that includes data access control logic configured to mediate communication between the first fault domain and the second fault domain without the need for an operating system;
processing the first output signal by a second program in the second fault domain to create a second output signal necessary for a safety-critical function, the processing by the second program being performed concurrently with and independently from the first program; and
including the second output in a safety critical control signal.

2. The method of claim 1, further comprising:
sending the safety critical control signal to an actuator for safety critical use.

3. The method of claim 1, wherein the first program is run independently of and concurrently with the second program.

4. The method of claim 1, wherein the digital communication channel defines a third fault domain.

5. The method of claim 4, wherein the first program is run on a first set of programmable logic gates, and wherein the further processing is run on a second set of programmable logic gates.

6. The method of claim 4 wherein the digital communication channel is a first digital communication channel, and further comprising:
running an additional program in a fourth fault domain to create an additional output signal,
sending the additional output signal from the fourth fault domain to a second digital communication channel;
sending, by the second digital communication channel, the additional output signal to the second fault domain for further processing by the second program to create an additional processed signal;
including the additional processed signal in a safety critical control signal; and
sending the safety critical control signal to an actuator for safety critical use.

7. An integrated circuit comprising:
a first fault domain including a first set of programmable logic gates configured to run a first program to create a first output;
a second fault domain including a second set of programmable logic gates configured to run a second program to create a second output; and
a digital communication channel in communication with the first set of programmable logic gates and a second set of programmable logic gate, the digital communication channel including data access control logic configured to mediate communication between the first fault domain and the second fault domain without the need for an operating system.

8. The integrated circuit of claim 7, wherein the second program is configured to process the first output signal by running the second program concurrently with and independently from the first program to create the second output signal.

9. The integrated circuit of claim 8, wherein the data access control logic is configured to determine whether the first output signal satisfies a predetermined policy, and if not, then refrain from sending at least a portion of the first output signal from the first fault domain to the second fault domain.

10. The integrated circuit of claim 8, wherein the digital communication channel is a third fault domain.

11. The integrated circuit of claim 8, wherein the second output signal is a safety critical control signal.

12. The integrated circuit of claim 8, the integrated circuit further comprising an output circuit configured to output the safety control signal.

13. The integrated circuit of claim 10, further comprising
an additional fault domain including a set of additional programmable logic gates configured to run an additional program to create an additional output signal;
and wherein the digital communication channel is in communication with the additional fault domain and is further configured to:
receive the additional output signal;
send the additional output signal to the second fault domain;
and wherein the second program is configured to process the additional output independently from and concurrently with the first program, and is further configured to output a second output signal.

14. The integrated circuit of claim 10, further comprising
an additional fault domain including a set of additional programmable logic gates configured to run an additional program to create an additional output signal;
a second digital communication channel in communication with the additional fault domain and configured to:
receive the additional output signal;
send the additional output signal to the second fault domain;
and wherein the second program is configured to process the additional output independently from and concurrently with the first program, and further configured to output a second output signal.

15. An integrated circuit comprising:
a first fault domain including a first set of programmable logic gates configured to run a first program to create a first output signal;
a second fault domain including a second set of programmable logic gates configured to run a second program concurrently with and independently from the first program to create a second output signal; and
a digital communication channel in communication with the first programmable logic gate and a second programmable logic gate, the communication being without the use of an operating system.

16. The integrated circuit of claim 15, wherein the digital communication channel includes mediation circuitry to determine whether the first output signal satisfies a predetermined policy, and to refrain from sending at least a portion of the first output signal to the second fault domain if the first output signal does not satisfy the predetermined policy.
